(19) United States
(12) Patent Application Publication
(10) Pub. No.: US 2023/0017042 A1
(43) Pub. Date: Jan. 19, 2023

(54) APPARATUS, METHOD, AND COMPUTER-READABLE MEDIUM

(71) Applicant: ASAHI KASEI KABUSHIKI KAISHA, Tokyo (JP)

(72) Inventors: Ippei KIMURA, Tokyo (JP); Tatsuya MORITA, Tokyo (JP)

(21) Appl. No.: 17/950,062

(22) Filed: Sep. 21, 2022

Related U.S. Application Data
(63) Continuation of application No. PCT/JP2021/014080, filed on Mar. 31, 2021.

(30) Foreign Application Priority Data
Mar. 31, 2020 (JP) 2020-064423

(51) Int. Cl. B29C 45/78

(52) U.S. Cl. CPC B29C 45/78; B29C 2045/7606

(57) ABSTRACT

An apparatus for assisting resin molding, including: a calculation unit for calculating, for each of a plurality of molding factors of the resin molding, a degree of influence on an analysis target characteristic of a resin molded article; a selection unit for selecting, based on the degree of influence, at least one molding factor among the plurality of molding factors; and a display processing unit for executing display processing for causing the selected at least one molding factor to be emphasized on a display of the plurality of molding factors displayed by the display device, is provided.

The contents of the following Japanese patent application(s) are incorporated herein by reference:
2020-064423 filed in JP on Mar. 31, 2020; and
PCT/JP2021/014080 filed in WO on Mar. 31, 2021.

### BACKGROUND

### 1. Technical Field

The present invention relates to an apparatus, a method, and a computer-readable medium.

### 2. Related Art

When resin is molded into an article, a molding condition needs to be adjusted by an operator of a fabrication apparatus in order to reduce occurrence of a defective product. Patent Document 1 describes about predicting a variation in an item to be evaluated under a molding condition, and graphically displaying a same in a way of assisting an operator.
Patent Document 1: Japanese Patent Application Publication No. 2006-123172

However, according to Patent Document 1, the operator will need to consider the variation in the item to be evaluated by changing many of those molding conditions, thus it takes a long time to adjust the molding conditions.

### BRIEF DESCRIPTION OF THE DRAWINGS

FIG. 1 illustrates a system 1 according to the present embodiment.

FIG. 2 illustrates one example of a screen 200 displayed by a display unit 70 of the present embodiment.

FIG. 3 illustrates another example of a screen 300 displayed by the display unit 70 of the present embodiment.

FIG. 4 illustrates a learning flow of a model in an assisting apparatus 3 of the present embodiment.

FIG. 5 illustrates a displaying flow of a molding factor in the assisting apparatus 3 of the present embodiment.

FIG. 6 illustrates one example of a parallel coordinate plot displayed by a display unit 70 of the present embodiment.

FIG. 7 illustrates another example of the parallel coordinate plot displayed by the display unit 70 of the present embodiment.

FIG. 8 illustrates one example of a radar chart displayed by the display unit 70 of the present embodiment.

FIG. 9 illustrates an example of a computer 2200 in which a plurality of aspects of the present invention may be embodied entirely or partially.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

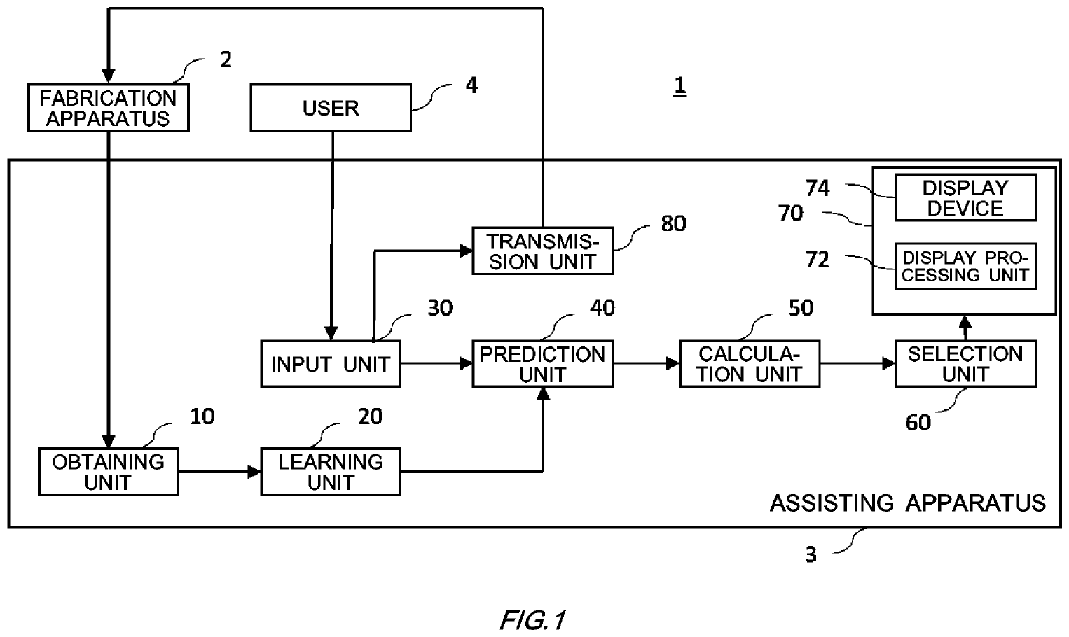

FIG. 1 illustrates a system 1 according to the present embodiment. The system 1 fabricates a resin molded article by adjusting a resin molding condition. The system 1 includes a resin molded article fabrication apparatus 2, and an assisting apparatus 3.

One example of a resin composition used for the fabrication of the resin molded article includes polyethylene, acrylonitrile, and polyamide, or reinforced plastic composed by adding resin with glass fiber and the like.

The fabrication apparatus 2 is connected to the assisting apparatus 3 via a wired or wireless connection, and fabricates the resin molded article molded into a desirable shape by injection molding, in-mold decoration, or the like. The fabrication apparatus 2 may evaluate a plurality of analysis target characteristics of molded resin i.e., a resin molded article, and transmit data representing a plurality of molding factors, and the analysis target characteristics of the molded resin to the assisting apparatus 3.

Here, the plurality of molding factors may be factors that affect quality of the resin molded article, which may include a molding condition set by the fabrication apparatus 2. The plurality of molding factors may be, by way of an example, at least one of a mold thickness, mold temperature, resin type, cooling time, injection temperature, maximum value of injection pressure, holding pressure, a number of screw-rotation, or measurement value. The plurality of molding factors may also include at least one of a temperature or a humidity in an environment where the fabrication apparatus 2 is installed, a molding shape, and the like.

The analysis target characteristic may be an evaluation item for determining whether the resin molded article is a defective product. The analysis target characteristic may include, by way of an example, at least one of a dimension of the resin molded article, a deviation from a target dimension, a defective mode, number, area, or density caused on the resin molded article, or a position where a defect is caused.

The assisting apparatus 3 is one example of an apparatus for assisting resin molding. The assisting apparatus 3 can assist in adjusting the molding condition by displaying the plurality of molding factors to a user such as an operator of the fabrication apparatus 2. The assisting apparatus 3 includes an obtaining unit 10, a learning unit 20, an input unit 30, a prediction unit 40, a calculation unit 50, a selection unit 60, and a display unit 70.

The obtaining unit 10 is connected to the fabrication apparatus 2. The obtaining unit 10 is configured to obtain learning data containing a set of values of the plurality of molding factors and a value of the analysis target characteristic, of which values have been taken from a result of resin molding in advance. The obtaining unit 10 may obtain the learning data from at least one of the fabrication apparatus 2, a website, or an external recording medium. The set of the values of the plurality of molding factors and the value of the analysis target characteristic may be a set of: set values of the plurality of molding factors at a time of resin molding in advance by the fabrication apparatus 2; and a value of the analysis target characteristic obtained by evaluating a resin molded article fabricated in this resin molding.

The learning unit 20 is connected to the obtaining unit 10. The learning unit 20 is configured to learn a model that generates, by using the learning data obtained by the obtaining unit 10, prediction data for the analysis target characteristic from the values of the plurality of molding factors. The learning unit 20 may generate and update the model by using the learning data.

The input unit 30 may be something for receiving an input from a user 4, such as a keyboard, mouse, or touch panel. The input unit 30 is subjected to be input data from the user 4, which represents at least one display condition (for example, at least one of a specification of at least one analysis target characteristic among the plurality of analysis target characteristics, or a specification of a targeted change for the analysis target characteristic) for the assisting apparatus 3 to display. The display condition includes at least one of ranges of the plurality of molding factors, a combination of certain values of the plurality of molding factors, or the analysis target characteristic, for example. The input unit 30 may also receive the data representing the display condition from a terminal such as a computer, tablet, or smart phone of the user 4. In addition, the input unit 30 may receive an input regarding a molding condition for molding by the fabrication apparatus 2.

The prediction unit 40 is connected to the learning unit 20 and the input unit 30. The prediction unit 40 receives from the learning unit 20, the model for generating the prediction data for the analysis target characteristic from the values of the plurality of molding factors, and holds this model. The prediction unit 40 is configured to generate, in response to the input unit 30 inputting data regarding at least one molding factor of the plurality of molding factors of the resin molding, prediction data for the analysis target characteristic by using the model and transmit this prediction data to the calculation unit 50. The prediction unit 40 may transmit the learning data obtained by the obtaining unit 10 to the calculation unit 50.

The calculation unit 50 is connected to the prediction unit 40. The calculation unit 50 is configured to calculate, for each of the plurality of molding factors of the resin molding, a degree of influence on the analysis target characteristic of molded resin. The calculation unit 50 may calculate the degree of influence by using the prediction data received from the prediction unit 40. The calculation unit 50 may calculate, for each of the plurality of molding factors, degrees of influence on the plurality of analysis target characteristics.

The selection unit 60 is connected to the calculation unit 50. The selection unit 60 is configured to select, based on the degree of influence received from the calculation unit 50, at least one molding factor among the plurality of molding factors. The selection unit 60 may select one or more molding factors that have large degrees of influence and thereby to be emphasized on the display.

The display unit 70 is connected to the selection unit 60. The display unit 70 has a display processing unit 72 and a display device 74. The display processing unit 72 is configured to execute display processing for causing the selected at least one molding factor to be emphasized on a display of the plurality of molding factors displayed by the display processing unit 72. The display processing unit 72 may execute processing for generating a display screen, processing for outputting data necessary for displaying (such as data representing the plurality of molding factors, data for the display screen, data representing an object to be emphasized on the display, data representing a method for emphasizing on the display) to the display device 74 via a wireless or wired connection, and the like. The display device 74 may be a display screen of the assisting apparatus 3. The display unit 70 may display at least one of a name of each molding factor, resin type, unit, available setting range such as a range of the molding factor input through the input unit 30, or latest set value such as a current optimized value. The display unit 70 may further display at least one of a name of the analysis target characteristic, the evaluation condition, or the prediction data.

The display unit 70 may display the selected at least one molding factor by emphasizing at least one of its color, pattern, marker, symbol, value of the degree of influence, rank of the degree of influence, magnitude of a numerical value, letter font, or letter size. For example, the display processing unit 72 may execute display processing for at least one of: causing the display device 74 to display the rank of the degree of influence near the display of the at least one molding factor selected by the selection unit 60; or causing the display device 74 to display at least a part of a plurality of degrees of influence in a predetermine format, in order to emphasize these on the display of the display device 74. The display unit 70 may display the plurality of molding factors on a screen of this display unit 70. In addition, the display unit 70 may output data for displaying the plurality of molding factors on an external display. The assisting apparatus 3 may also have a transmission unit 80 for transmitting the molding condition to the fabrication apparatus 2. The transmission unit 80 may receive the molding condition input into the input unit 30, and transmit it to the fabrication apparatus 2.

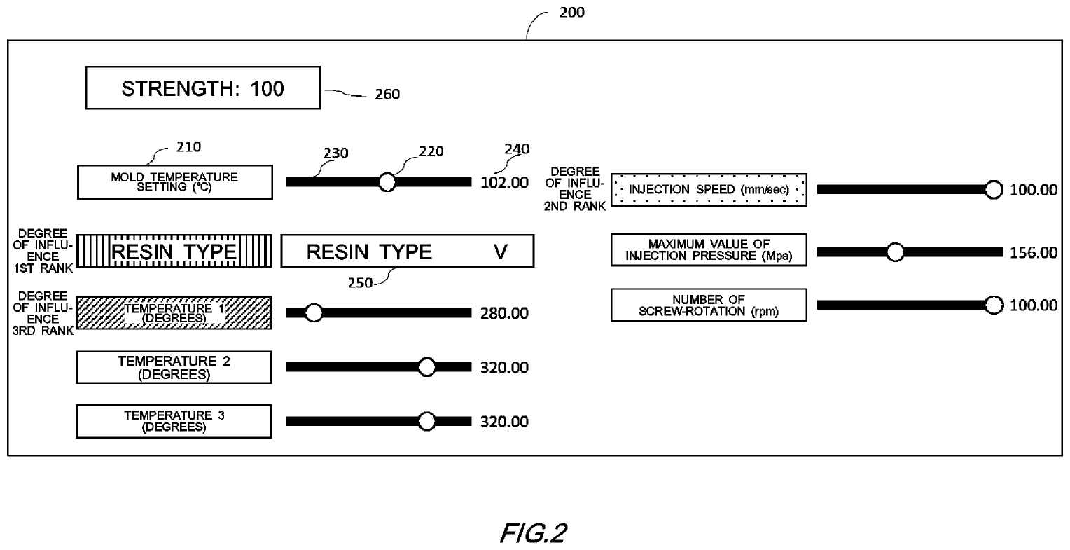

FIG. 2 illustrates one example of a screen 200 displayed by the display unit 70 in the present embodiment. The display unit 70 displays on the screen 200, an item name 210 of the each molding factor, a slider bar 230 indicating the available setting range of the molding factor, a pointer 220 indicating a position of a current value on the slider bar 230, a current value 240 of the molding factor, a list box 250 for the resin type, and a predicted value 260 for the analysis target characteristic for a case of a combination of the current values of the molding factor. In FIG. 2, the predicted value 260 of the analysis target characteristic indicates that the predicted value of strength of a resin molded article in the injection molding is 100. The user 4 can change values of the molding factors by looking at the screen 200, using a mouse i.e., the input unit 30, and moving the pointer 220 with a mouse pointer, by which the predicted value 260 for the analysis target characteristic predicted by the prediction unit 40 based on the change in a combination of values of these molding factors changes in real-time on the screen, and thereby the user 4 can easily determine the molding condition. At this time, the molding factor to be emphasized on the display based on the degree of influence may change.

In the present embodiment, the display unit 70 emphasizes the molding factors selected by the selection unit 60 and having the degrees of influence ranked from 1 to 3 on the display, in which boxes of their item names (resin type, injection speed, and temperature 1 in FIG. 2) are displayed in color (or patterns) different from others, and the ranks of the degrees of influence are indicated at positions next to the item names.

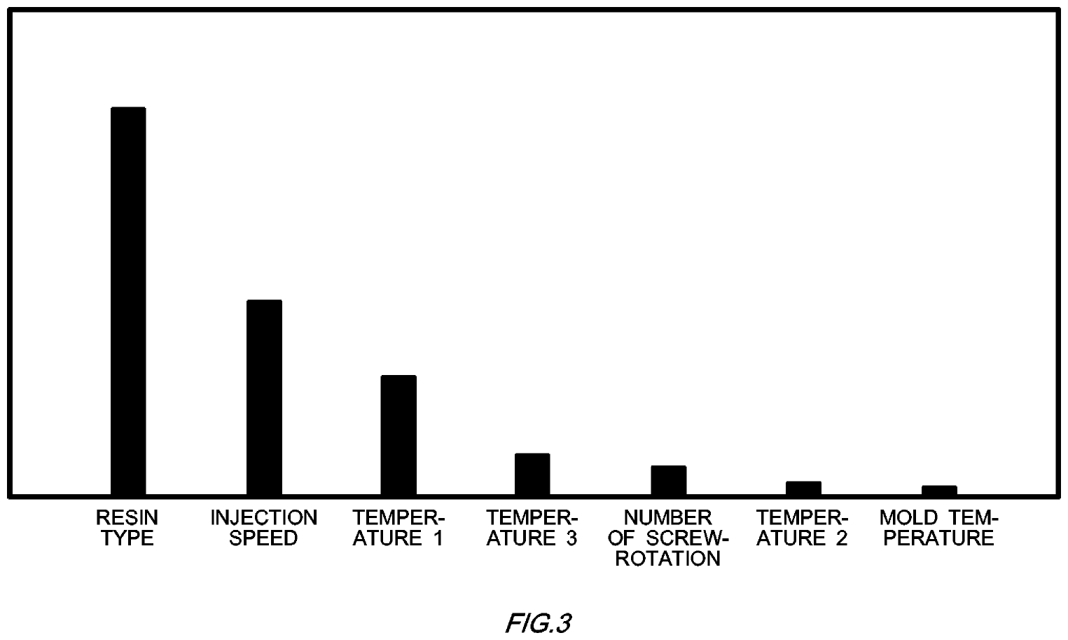

FIG. 3 illustrates another example of a screen 300 displayed by the display unit 70 of the present embodiment. The display unit 70 displays on the screen 300, a graph having a horizontal axis representing an item name of each molding factor, and a vertical axis representing the degree of influence of each molding factor. In the graph of FIG. 3, the display unit 70 emphasizes the plurality of molding factors on the display by arranging them in a descending order according to their degrees of influence. In FIG. 3, the display unit 70 may show on the vertical axis, the values of the degrees of influence which are standardized by the calculation unit 50 in a way that a total of the degrees of influence becomes 1.

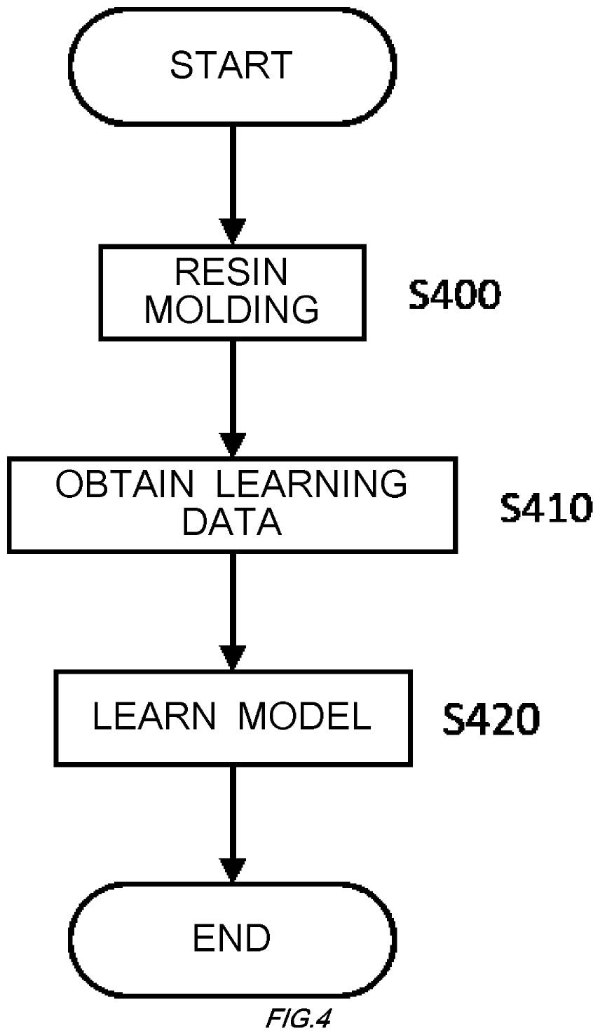

FIG. 4 illustrates a learning flow of the model in the assisting apparatus 3 of the present embodiment. In step S400, the fabrication apparatus 2 performs resin molding. The fabrication apparatus 2 may perform the resin molding for a number of times by changing the molding condition of the resin molded article.

In step S410, the obtaining unit 10 obtains the learning data from the fabrication apparatus 2. The obtaining unit 10 may receive a plurality of combinations of values of the plurality of molding factors and a value of the analysis target characteristic from the fabrication apparatus 2. Also, the obtaining unit 10 may obtain values of the plurality of molding factors, and measurement data of the resin molded article such as a measurement value of a dimension of the molded resin, and an image data from the fabrication apparatus 2, and then obtain the value of the analysis target characteristic by evaluating the resin molded article by the obtaining unit 10.

In step S420, the learning unit 20 learns the model that generates, by using the learning data obtained by the obtaining unit 10, the prediction data for the analysis target characteristic from the values of the plurality of molding factors. The model may be, by way of an example, for a machine learning algorithm including neural networks of a recurrent type, time-delay type, etc., random forest, gradient boosting, logistic regression, support-vector machine (SVM), and the like. For example, the model may include a node corresponding to each element of the molding factor in an input layer, and a node corresponding to the analysis target characteristic in an output layer. There may be one or more nodes in the input layer for one element of the molding factor. An intermediate layer, i.e., a hidden layer, including one or more nodes may be interposed between the input layer and the output layer. The learning unit 20 may execute learning processing by adjusting a weight of an edge connecting the nodes, and a bias value of an output node.

In response to the obtaining unit 10 obtaining the learning data in S410, or based on an input from the user 4, the learning unit 20 may periodically learn and update the model. The learning flow may end when a power supply of the assisting apparatus 3 is turned off.

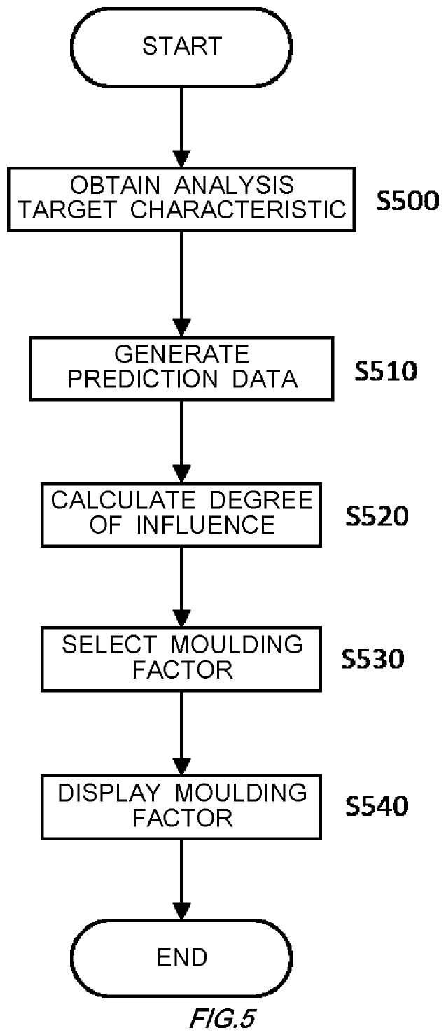

FIG. 5 illustrates a displaying flow of the molding factor in the assisting apparatus 3 of the present embodiment. In step S500, the input unit 30 obtains a specification of the analysis target characteristic, e.g., strength, from the user 4.

In step S510, the prediction unit 40 uses the model and generates from the plurality of molding factors, prediction data for a certain analysis target characteristic obtained by the input unit 30. The prediction unit 40 may generate as the prediction data, a plurality of values (or changes) of the analysis target characteristic in a case of changing a corresponding molding factor among the plurality of molding factors within a predetermined range. The predetermined range to change may be, for example, a range that is input through the input unit 30 from the user 4 with regard to each molding factor, or an available setting range for a fabrication apparatus 2 obtained from the fabrication apparatus 2 through the obtaining unit 10.

In step S520, the calculation unit 50 may calculate the degree of influence by using the prediction data from the prediction unit 40, the input data obtained by the input unit 30, the learning data obtained by the obtaining unit 10, and the like. The calculation unit 50 may calculate, among the plurality of combinations of values of the plurality of molding factors, the degree of influence by using a current optimized value being a combination of values with which the analysis target characteristic becomes excellent or becomes closest to a target value as a standard. The calculation unit 50 may also use as the optimized value being the standard, a combination of the latest values of the plurality of molding factors obtained by the obtaining unit 10, or a combination of values of the plurality of molding factors input through the input unit 30. The calculation unit 50 may calculate as the degree of influence, a degree of change of each molding factor in a case of changing the each molding factor from the standard within a predetermined range (±x %) (x>0) while other molding factors are fixed at the optimized value, for example. The calculation unit 50 may calculate the degree of influence with a plurality of standards and for a plurality of ranges. This predetermined range for the changed may be a range smaller than or the same as the predetermined range used by the prediction unit 40, and may be a range different for every molding factor.

The calculation unit 50 may calculate, as the degree of influence for each of the plurality of molding factors, a changed degree such as an absolute value of a changed rate of the analysis target characteristic in a case of changing a corresponding molding factor. For example, the calculation unit 50 may calculate an absolute value of a changed rate of each analysis target characteristic for a plurality of sections, in other words, unit sections created by dividing the predetermined range, average the absolute values of the changed rates for the plurality of sections, and use the result as the degree of influence. In this way, the calculation unit 50 can more accurately calculate a degree of change even when a changed rate of the analysis target characteristic changes from negative to positive. In addition, the calculation unit 50 may calculate as the degree of influence, an absolute value of a changed rate, i.e., differentiated value in a small unit section where a current value of the molding factor is included.

The calculation unit 50 may calculate a standardized value by dividing the calculated degree of influence by a total of the degrees of influence of all molding factors. Here, the calculation unit 50 may divide all of the molding factors in the unit sections where the values of the molding factors are changed by the available setting range, i.e., a width between a maximum value and a minimum value of a corresponding molding factor, so that the standardized values are set to be a same. Thereby, the degree of influence can be calculated with high accuracy between a molding factor having a large available setting range and a molding factor having a small available setting range.

The calculation unit 50 transmits the degree of influence of each of the plurality of molding factors to the selection unit 60.

In step S530, the selection unit 60 selects the molding factor based on the degree of influence calculated by the calculation unit 50. The selection unit 60 may execute at least one of: selecting, among the plurality of molding factors, at least one molding factor having the degree of influence ranked within predetermined ranks in a descending order (or ascending order); or selecting, among the plurality of molding factors, at least one molding factor having the degree of influence being a predetermined threshold value or more (or less than the predetermined threshold value). The selection unit 60 may select a number of molding factors predetermined for every analysis target characteristic, or a number of molding factors specified by the user 4 through the input unit 30, in a descending order (or ascending order) with regard to their degrees of influence. Also, the selection unit 60 may select a molding factor having the degree of influence being the predetermined threshold value for every analysis target characteristic, or being the threshold value specified by the user 4 through the input unit 30, or more (or less).

In step S540, the display unit 70 displays the plurality of molding factors on the screen while emphasizing the molding factor selected by the selection unit 60 on the display. For example, the display unit 70 may generate and display a screen such as those of FIG. 2 or 3. The display unit 70 may display a current combination of the plurality of molding factors as well as the prediction data for the analysis target characteristic for the current combination. The display unit 70 may display, among the plurality of combinations of the plurality of molding factors, a combination of optimal values, a combination of current values most recently obtained, or a combination of values input by the user through the input unit. The display unit 70 may also generate and output data for the screen, and cause an external display such as a terminal of the user 4 or the fabrication apparatus 2 to display this data.

Here, the assisting apparatus 3 may start, in response to obtaining an input for changing at least one molding factor from the input unit 30 the flow from any of step S510, S520, and S530 for a combination with the changed plurality of molding factors. In this way, the assisting apparatus 3 can change the display, for example, change the molding factor to be emphasized on the display, in real-time based on the degree of influence changed according to the changed plurality of molding factors. The assisting apparatus 3 may end the processing when the power supply is turned off.

According to the present embodiment, the user can easily distinguish a molding factor having a large effect on a certain analysis target characteristic, and efficiently adjust the molding condition in the fabrication apparatus 2. In addition, calculating the degree of influence based on a predicted analysis target characteristic enables the molding condition to be adjusted by calculating the degree of influence without actually performing resin molding for many times, and thereby reduction in resin molding cost, reduction in a period of time for a product to be resin molded, improvement in an operation rate of the fabrication apparatus, and the like can be achieved.

Note that, the assisting apparatus 3 may not be connected to the fabrication apparatus 2, and the obtaining unit 10 may obtain as the learning data, data of resin molding in another fabrication apparatus, data stored in a recording medium, or website data.

Further, the assisting apparatus 3 may not include the learning unit 20, and thus may be provided with the model from an external learning apparatus.

The assisting apparatus 3 can calculate, when the plurality of analysis target characteristics is specified by the user 4, the degrees of influence on the plurality of analysis target characteristics, and emphasize the result on the display. The calculation unit 50 may calculate the degree of influence on each of the plurality of analysis target characteristics, and select the molding factor based on a total of the degrees of influence. For example, the calculation unit 50 divides each of changed values of the plurality of analysis target characteristics in a case of changing the molding factor in unit sections, by a width between a maximum value and a minimum value in an available changing range of a corresponding analysis target characteristic, and standardize the result. Then, the calculation unit 50 may calculate a total of the standardized changes of the analysis target characteristic, and obtain this total as the degree of influence.

Note that, the calculation unit 50 of the assisting apparatus 3 may calculate, for each of the plurality of molding factors, degrees of influence on the plurality of analysis target characteristics. Hereinafter, functions, operations, and the like being the same as those of the above-described embodiment will be omitted.

In step S500, the input unit 30 obtains from the user 4, at least one of a specification of one or more first analysis target characteristics, or another one or more second analysis target characteristics. In step S510, the prediction unit 40 uses the model and generates from the plurality of molding factors, prediction data for the first analysis target characteristic and prediction data for the second analysis target characteristic. The one or more second analysis target characteristics may be obtained with the first analysis target characteristic from the user 4 through the input unit 30, or may also be predetermined. In step S520, the calculation unit 50 may calculate the degrees of influence of the plurality of molding factors for the first analysis target characteristic and the second analysis target characteristic by using the prediction data from the prediction unit 40, the input data obtained by the input unit 30, the learning data obtained by the obtaining unit 10, and the like.

In step S530, the selection unit 60 selects the molding factor based on the degree of influence. The selection unit 60 may select at least one molding factor having the degree of influence on a specified at least one first analysis target characteristic being greater than a first threshold; and the degree of influence on the other at least one second analysis target characteristic being smaller than a second threshold. In this way, the selection unit may select a molding factor having the degree of influence on a specified first analysis target characteristic being greater than the first threshold, and the molding factor of which change does not cause a second analysis target characteristic to go out of a predetermined range. The selection unit 60 may also select one or more molding factors having the largest degree of influence on the first analysis target characteristic from the calculated degrees of influence on the first analysis target characteristic and the second analysis target characteristic, for example. The first threshold and the second threshold may be values obtained with the analysis target characteristic from the user 4 through the input unit 30, predetermined values, or values according to a predetermined regulation.

By way of an example, the selection unit 60 can select a molding factor having a large degree of influence on strength but small degree of influence on impact resistance, e.g., a mold temperature, and cause the display device 74 to display this molding factor.

In addition, in step S530, the selection unit 60 may select at least one molding factor based on the degree of influence on each analysis target characteristic in a case of causing a targeted change on each analysis target characteristic. The selection unit 60 may select a molding factor having the degree of influence on the first analysis target characteristic being greater than a third threshold in a case of causing a targeted change on the first analysis target characteristic, and the molding factor of which change causes a targeted change on the second analysis target characteristic. The targeted change may be a change of the analysis target characteristic from a current value, e.g., a value at the current optimal condition, and may be at least one of a positive or negative change of a corresponding analysis target characteristic, a target range of the corresponding analysis target characteristic, or a range of a ratio of the degrees of influence of the plurality of analysis target characteristics. The targeted change may be a change associated with the analysis target characteristic and obtained from the user 4 through the input unit 30, or may also be a predetermined change or a change according to a predetermined regulation.

Specifically, in step S500, the user 4 inputs into the input unit 30, targeted changes for strength and a number of defects being the analysis target characteristics, by which the strength will be positive, and the number of defects will be negative. Based on this, the selection unit 60 may select a molding factor that has the degree of influence for causing the strength to be positive being greater than the third threshold, and causing the number of defects to be at least negative.

In step S540, the display unit 70 displays degrees of influence of the molding factors for the plurality of analysis target characteristics on the screen of the display device 74 while emphasizing the molding factor selected by the selection unit 60 on the display. The display processing unit 72 may execute display processing for causing the display device 74 to display a parallel coordinate plot or a radar chart which shows the degrees of influence of the plurality of molding factors. An example of the display screen will be described below.

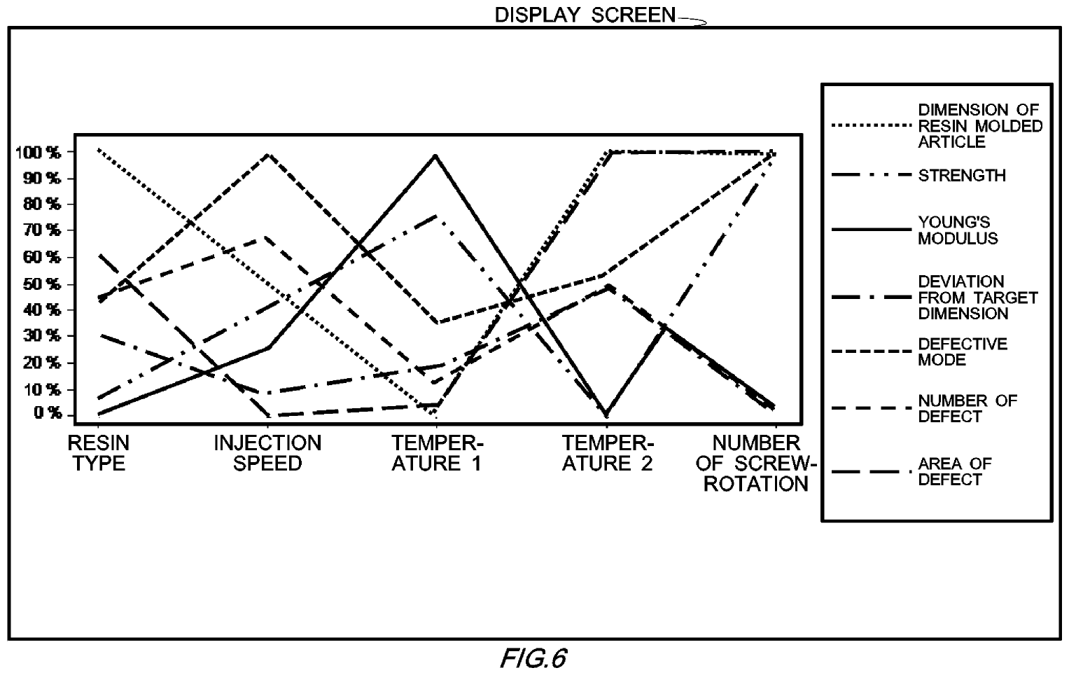

FIG. 6 illustrates one example of the parallel coordinate plot showing the degrees of influence of the plurality of molding factors. In the graph of FIG. 6, the vertical axis shows as the degrees of influence, changed degrees of the analysis target characteristics in a case of changing corresponding molding factors, and the horizontal axis represents types of the molding factors. In FIG. 6, the degree of influence may be displayed with a solid line in order to emphasize Young's modulus on the display.

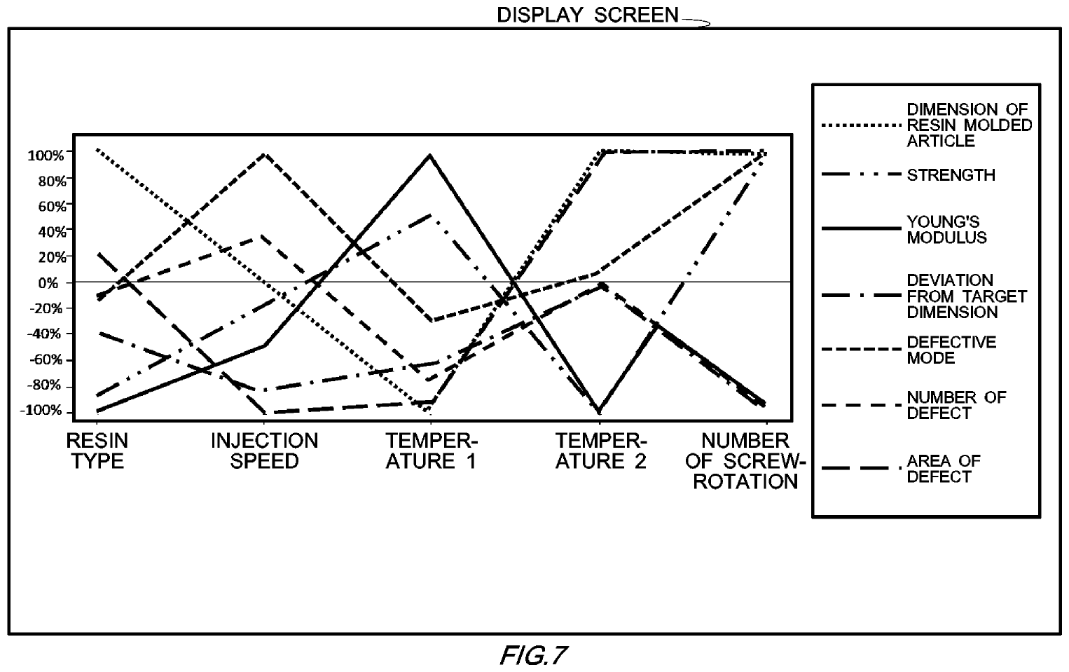

FIG. 7 illustrates another example of the parallel coordinate plot showing the degrees of influence of the plurality of molding factors. In the graph of FIG. 7, the vertical axis shows as the degrees of influence, changes of the analysis target characteristics from a reference value in a case of changing corresponding molding factors, and the horizontal axis represents types of the molding factors. In FIG. 7, the degree of influence may be displayed with a solid line in order to emphasize Young's modulus on the display. In FIG. 7, being positive/negative from the reference value, e.g., a value at the current optimal condition, of the analysis target characteristics is clearly shown.

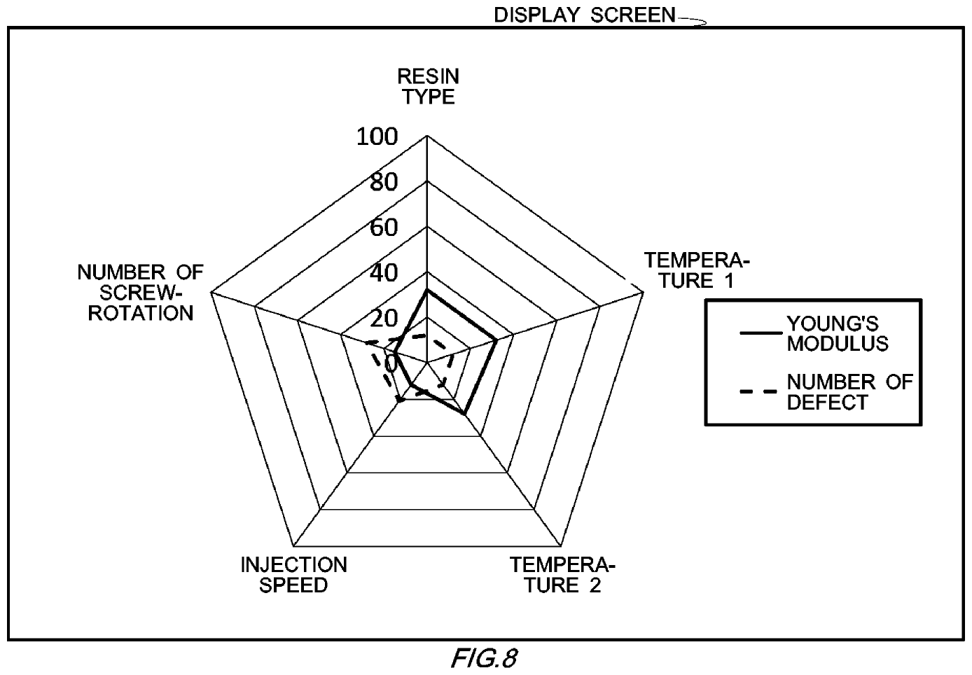

FIG. 8 illustrates one example of a radar chart illustrating the degrees of influence of the plurality of molding factors. In the graph of FIG. 8, the five items represent types of molding factors and a changed degree of the analysis target characteristic in a case of changing a corresponding molding factor is shown as the degrees of influence. In FIG. 8, the degree of influence may be displayed with a solid line in order to emphasize Young's modulus on the display.

According to such an embodiment described above, the molding condition can be efficiently adjusted based on the degrees of influence of the plurality of analysis target characteristics without actually performing resin molding for many times, and thereby reduction in resin molding cost, reduction in a period of time for a product to be resin molded, improvement in an operation rate of the fabrication apparatus, and the like can be achieved. Note that, the display device 74 may also be an external display device of the assisting apparatus 3 such as a display screen of a terminal of the user 4, or a display screen of the fabrication apparatus 2. Further, the assisting apparatus 3 may be a PC, server, mobile terminal, or the like.

In addition, various embodiments of the present invention may also be described with reference to flowcharts and block diagrams, in which a block may represent (1) a stage of a process in which an operation is performed or (2) a section of an apparatus that has a role of performing the operation. Certain stages and sections may be implemented by dedicated circuitry, programmable circuitry provided with computer-readable instructions stored on a computer-readable medium, and/or a processor provided with computer-readable instructions stored on a computer-readable medium. The dedicated circuitry may include a digital and/or analog hardware circuit, or may include an integrated circuit (IC) and/or a discrete circuit. The programmable circuitry may include a reconfigurable hardware circuit including logical AND, logical OR, logical XOR, logical NAND, logical NOR, and other logical operations, a memory element such as a flip-flop, a register, a field programmable gate array (FPGA) and a programmable logic array (PLA), and the like.

The computer-readable medium may include any tangible device capable of storing instructions for execution by a suitable device, so that the computer-readable medium having the instructions stored therein will have a product including instructions that can be executed to create means for performing the operations designated in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random-access memory (SRAM), a compact disc read-only memory (CD-ROM), a digital versatile disk (DVD), a BLU-RAY (registered trademark) disk, a memory stick, an integrated circuit card, and the like.

The computer-readable instructions may include assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Smalltalk (registered trademark), JAVA (registered trademark), C++, etc., and conventional procedural programming languages, such as the “C” programming language or similar programming languages.

The computer-readable instructions may be provided to a processor of a general purpose computer, special purpose computer, or other programmable data processing apparatus, or to programmable circuitry, locally or via a local area network (LAN), wide area network (WAN) such as the Internet, or the like, to execute the computer-readable instructions to create means for performing operations specified in the flowcharts or block diagrams. Examples of the processor include a computer processor, processing unit, microprocessor, digital signal processor, controller, microcontroller, and the like.

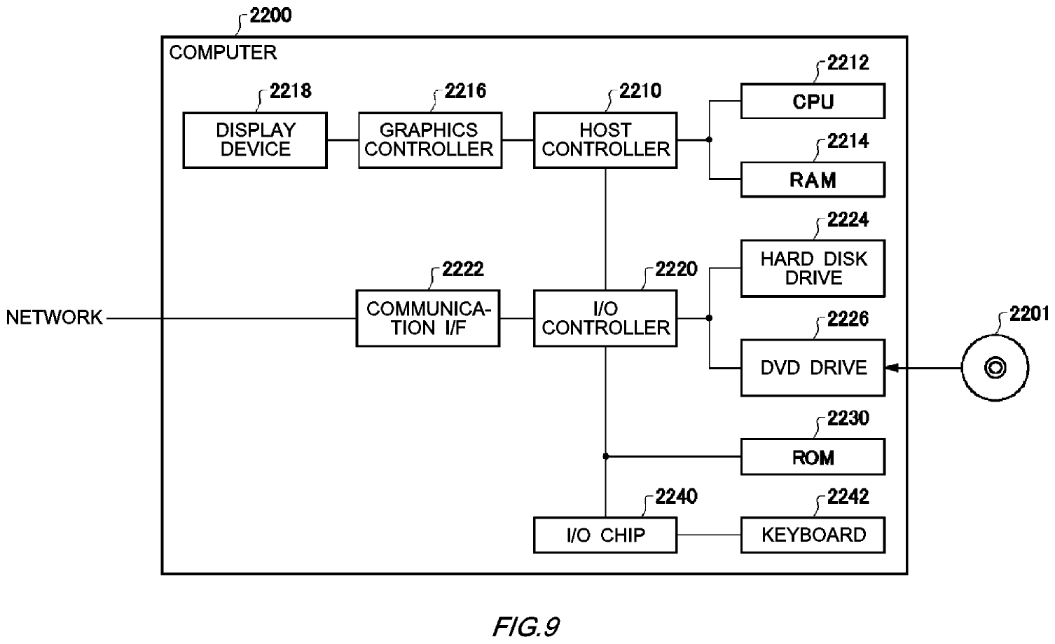

FIG. 9 illustrates an example of a computer 2200 in which a plurality of aspects of the present invention may be embodied entirely or partially. A program installed in the computer 2200 can cause the computer 2200 to function as operations associated with the apparatus of the embodiments of the present invention or one or more sections thereof, or cause the computer 2200 to execute these operations or the one or more sections, and/or cause the computer 2200 to perform processes of the embodiments of the present invention or stages thereof. Such a program may be executed by the CPU 2212 to cause the computer 2200 to perform certain operations associated with some or all of the blocks of flowcharts and block diagrams described herein.

The computer 2200 according to the present embodiment includes a CPU 2212, a RAM 2214, a graphics controller 2216, and a display device 2218, which are mutually connected by a host controller 2210. The computer 2200 also includes an input/output unit such as a communication interface 2222, a hard disk drive 2224, a DVD-ROM drive 2226, and an IC card drive, which are connected to the host controller 2210 through an input/output controller 2220. The computer also includes legacy input/output units such as a ROM 2230 and a keyboard 2242, which are connected to the input/output controller 2220 through an input/output chip 2240.

The CPU 2212 operates in accordance with programs stored in the ROM 2230 and the RAM 2214, thereby controlling each unit. The graphics controller 2216 obtains image data generated by the CPU 2212 on a frame buffer or the like provided in the RAM 2214 or in the RAM 2214 itself, and causes the image data to be displayed on the display device 2218.

The communication interface 2222 communicates with another electronic device via a network. The hard disk drive 2224 stores programs and data used by the CPU 2212 in the computer 2200. The DVD-ROM drive 2226 reads the programs or the data from the DVD-ROM 2201, and provides the hard disk drive 2224 with the programs or the data via the RAM 2214. The IC card drive reads the programs and the data from an IC card, and/or writes the programs and the data into the IC card.

The ROM 2230 stores therein a boot program or the like executed by the computer 2200 at a time of activation, and/or a program dependent on the hardware of the computer 2200. The input/output chip 2240 may also connect various input/output units through a parallel port, a serial port, a keyboard port, a mouse port, or the like to the input/output controller 2220.

A program is provided by a computer-readable medium such as the DVD-ROM 2201 or the IC card. The program is read from the computer-readable medium, installed into the hard disk drive 2224, RAM 2214, or ROM 2230, which are also examples of computer-readable media, and then executed by the CPU 2212. Information processing written in these programs is read by the computer 2200, and provides cooperation between the programs and the various types of hardware resources described above. An apparatus or method may be configured by using the computer 2200 and thereby conducting the operations or processing on information.

For example, when communication is executed between the computer 2200 and an external device, the CPU 2212 may execute a communication program loaded onto the RAM 2214, and instruct the communication interface 2222 to process the communication based on the processing written in the communication program. Under the control of the CPU 2212, the communication interface 2222 reads transmission data stored in a transmission buffer processing region provided in a recording medium such as the RAM 2214, the hard disk drive 2224, the DVD-ROM 2201, or the IC card, transmits the read transmission data to the network, or writes reception data received from the network in a reception buffer processing region or the like provided on the recording medium.

In addition, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, etc. and execute various types of processing on data on the RAM 2214. The CPU 2212 may then write back the processed data to the external recording medium.

Various types of information, such as various types of programs, data, tables, and databases, may be stored in the recording medium to be processed. The CPU 2212 may execute various types of processing on the data read from the RAM 2214, which includes various types of operations, information processing, conditional judgement, conditional branching, unconditional branching, information retrieval/replacement, etc., as described throughout the present disclosure and specified by an instruction sequence of the programs, and writes a result back to the RAM 2214. In addition, the CPU 2212 may retrieve information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The program or software modules described above may be stored in the computer-readable medium on or near the computer 2200. In addition, a recording medium such as a hard disk or a RAM provided in a server system connected to a dedicated communication network or the Internet can be used as the computer-readable medium, thereby providing the program to the computer 2200 via the network.

While the embodiments of the present invention have been described, the technical scope of the present invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the present invention.

The operations, procedures, steps, stages, and the like of each process performed by an apparatus, system, program, and method shown in the claims, specification, drawings can be performed in any order as long as the order is not indicated by “prior to,” “before,” or the like and as long as the output from a previous process is not used in a later process. Even if the operation flow is described using phrases such as “first” or “next” in the claims, specification, or drawings, it does not necessarily mean that the process must be performed in this order.

What is claimed is:

1. An apparatus configured to assist resin molding, comprising:
a calculation unit for calculating, for each of a plurality of molding factors of the resin molding, a degree of influence on an analysis target characteristic of a resin molded article;
a selection unit for selecting, based on the degree of influence, at least one molding factor among the plurality of molding factors; and
a display processing unit for executing display processing for causing the selected at least one molding factor to be emphasized on a display of the plurality of molding factors displayed by a display device.

2. The apparatus according to claim 1, wherein the display processing unit is configured to execute display processing for at least one of: causing the display device to display a rank of the degree of influence near a display of the selected at least one molding factor; or causing the display device to display at least a part of a plurality of the degrees of influence in a predetermined format.

3. The apparatus according to claim 1, wherein the selection unit is configured to execute at least one of: selecting, among the plurality of molding factors, at least one molding factor having the degree of influence ranked within predetermined ranks in a descending order; or selecting, among the plurality of molding factors, at least one molding factor having the degree of influence being a predetermined threshold value or more.

4. The apparatus according to claim 2, wherein the selection unit is configured to execute at least one of: selecting, among the plurality of molding factors, at least one molding factor having the degree of influence ranked within predetermined ranks in a descending order; or selecting, among the plurality of molding factors, at least one molding factor having the degree of influence being a predetermined threshold value or more.

5. The apparatus according to claim 1, wherein the calculation unit is configured to calculate, as the degree of influence for each of the plurality of molding factors, an absolute value of a changed rate of the analysis target characteristic in a case of changing a corresponding one among the plurality of molding factors.

6. The apparatus according to claim 2, wherein the calculation unit is configured to calculate, as the degree of influence for each of the plurality of molding factors, an absolute value of a changed rate of the analysis target characteristic in a case of changing a corresponding one among the plurality of molding factors.

7. The apparatus according to claim 1, further comprising:
a prediction unit which includes a model for generating prediction data for the analysis target characteristic from values of the plurality of molding factors, and which is for generating by using the model, in response to data regarding at least one of the plurality of molding factors of the resin molding being input, the prediction data for the analysis target characteristic.

8. The apparatus according to claim 2, further comprising:
a prediction unit which includes a model for generating prediction data for the analysis target characteristic from values of the plurality of molding factors, and which is for generating by using the model, in response to data regarding at least one of the plurality of molding factors of the resin molding being input, the prediction data for the analysis target characteristic.

9. The apparatus according to claim 1, further comprising:
an obtaining unit configured to obtain learning data containing a set of values of the plurality of molding factors and a value of the analysis target characteristic, of which values have been taken from a result of performing resin molding in advance; and
a learning unit configured to learn a model that generates, by using the learning data, prediction data for the analysis target characteristic from the values of the plurality of molding factors.

10. The apparatus according to claim 2, further comprising:
an obtaining unit configured to obtain learning data containing a set of values of the plurality of molding factors and a value of the analysis target characteristic, of which values have been taken from a result of performing resin molding in advance; and
a learning unit configured to learn a model that generates, by using the learning data, prediction data for the analysis target characteristic from the values of the plurality of molding factors.

11. The apparatus according to claim 1, wherein
the calculation unit is configured to calculate, for each of the plurality of molding factors, the degrees of influence on plurality of analysis target characteristics; and
the selection unit is configured to select at least one molding factor having the degree of influence on a specified at least one analysis target characteristic being greater than a first threshold, and the degree of influence on at least another analysis target characteristic being smaller than a second threshold.

12. The apparatus according to claim 11, wherein the selection unit is configured to select a molding factor having the degree of influence on a first analysis target characteristic being greater than a first threshold, and the molding factor of which change does not cause a second analysis target characteristic to go out of a predetermined range.

13. The apparatus according to claim 1, wherein
the calculation unit is configured to calculate, for each of the plurality of molding factors, the degrees of influence on plurality of analysis target characteristics; and
the selection unit is configured to select at least one molding factor based on a degree of influence on each analysis target characteristic in a case of causing a targeted change on each analysis target characteristic.

14. The apparatus according to claim 13, wherein the selection unit is configured to select a molding factor having the degree of influence on a first analysis target characteristic being greater than a third threshold in a case of causing a targeted change on the first analysis target characteristic, and the molding factor of which change causes a targeted change on a second analysis target characteristic.

15. The apparatus according to claim 11, comprising:
an input unit configured to receive from a user, at least one of: a specification of at least one analysis target characteristic among the plurality of analysis target characteristics; or a specification of a targeted change for the analysis target characteristic.

16. The apparatus according to claim 1, wherein the display processing unit is configured to execute display processing for causing the display device to display a parallel coordinate plot or a radar chart which shows degrees of influence of the plurality of molding factors.

17. A method for assisting resin molding, comprising:
calculating, for each of a plurality of molding factors of the resin molding, a degree of influence on an analysis target characteristic of a resin molded article;
selecting, based on the degree of influence, at least one molding factor among the plurality of molding factors; and
executing display processing for causing the selected at least one molding factor to be emphasized on a display of the plurality of molding factors displayed by a display device.

18. The method according to claim 17, further comprising:
executing display processing for causing the display device to display a current combination of the plurality of molding factors, as well as causing the display device to display prediction data for the analysis target characteristic for the current combination.

19. The method according to claim 18, further comprising:
executing display processing for causing the display device to display an optimal combination among a plurality of combinations of the plurality of molding factors.

20. A computer-readable medium having stored therein a program configured to cause a computer to perform operations comprising:
calculating, for each of a plurality of molding factors of resin molding, a degree of influence on an analysis target characteristic of a resin molded article;
selecting, based on the degree of influence, at least one molding factor among the plurality of molding factors; and
executing display processing for causing the selected at least one molding factor to be emphasized on a display of the plurality of molding factors displayed by a display device.
